(19) United States
(12) Patent Application Publication
(10) Pub. No.: US 2014/0071038 A1
(43) Pub. Date: Mar. 13, 2014

(54) METHOD FOR GENERATING MOVEMENT POSITION COORDINATE AND HUMAN-MACHINE INTERFACE INPUT SYSTEM USING THE SAME

(71) Applicant: AU OPTRONICS CORP., Hsin-Chu (TW)

(72) Inventors: Yi-Min LI, Hsin-Chu (TW); Sheng-Yun CHANG, Hsin-Chu (TW); Sin-Guo JHOU, Hsin-Chu (TW); Yu-Min HSU, Hsin-Chu (TW)

(73) Assignee: AU OPTRONICS CORP., Hsin-Chu (TW)

(21) Appl. No.: 13/959,918

(22) Filed: Aug. 6, 2013

(30) Foreign Application Priority Data
Sep. 7, 2012 (TW) 101132791

(51) Int. Cl. G06F 3/01

(52) U.S. Cl. CPC G06F 3/01
USPC 345/156

(57) ABSTRACT

A method for generating a movement position coordinate adapted to be used in a human-machine interface input controller is provided. The method includes steps of: sequentially generating a plurality of position coordinates by detecting a movement of an object; reading and storing the position coordinates; performing, when the number of the stored position coordinates reaches to a predetermined value, an operation on the position coordinates to obtain a movement position coordinate; and modulating the predetermined value in accordance with a change of a movement rate of the object.

### TECHNICAL FIELD

The present disclosure relates to method and device for generating a movement position coordinate and corresponding human-machine interface input device system, and more particularly to method and device and corresponding human-machine interface input system for a movement position coordinate adapted to be used in a human-machine interface input controller.

### BACKGROUND

Human-machine interface input devices, such as touch pad and touch panel, are widely used in today's electronic products. By touching or drawing on a panel of a human-machine interface input device with an object (a finger or a pen), a user can control the electronic product. Specifically, a controlling circuit of the human-machine interface input device is configured to sample the touched-point position coordinates on the panel and accordingly detect the movement track of the object. To convert the movement track with jitter into a smooth curve and thereby having an improved linearity, conventionally the controlling circuit uses a smooth buffer with constant length to store the touched-point position coordinates and averages, when the smooth buffer is full, the touched-point position coordinates to obtain a movement position coordinate of the touched-point position coordinates. However, the track linearity effect may be affected by the varying movement rates of the object (a finger of a user or a touch pen). For example, as illustrated in FIG. 1A, the figure is shown that the object has a higher movement rate and the object has a lower movement rate, as illustrated in FIG. 1B; and the track linearity effects of the both are poor if the buffer size is fixed.

### SUMMARY

The present disclosure provides a method for generating a movement position coordinate adapted to be used in a human-machine interface input controller, the method comprising steps of: sequentially generating a plurality of position coordinates by detecting a movement of an object; reading and storing the position coordinates; performing, when the number of the stored position coordinates reaches to a predetermined value, an operation on the position coordinates to obtain a movement position coordinate; and modulating the predetermined value in accordance with a change of a movement rate of the object.

The present disclosure further provides a device for generating a movement position coordinate adapted to be used in a human-machine interface input controller. The human-machine interface input controller is configured to sequentially generate a plurality of position coordinates in response to a movement of an object. The device includes a storage unit and an operation unit. The storage unit is configured to store the position coordinates. The operation unit is in communication with the storage unit and configured to perform, when the number of the stored position coordinates reaches to a predetermined value, an operation on the position coordinates to obtain a movement position coordinate and modulate the predetermined value in accordance with a change of a movement rate of the object.

The present disclosure still further provides a human-machine interface input system with a regulative buffer size. The system includes a storage unit and an operation unit. The storage unit is configured to store a plurality of position coordinates sequentially generated by the human-machine interface input system in response to a movement of an object. The operation unit is in communication with the storage unit and configured to perform, when the number of the stored position coordinates reaches to a predetermined value, an operation on the position coordinates to obtain a movement position coordinate and modulate the predetermined value in accordance with a change of a movement rate of the object.

### BRIEF DESCRIPTION OF THE DRAWINGS

The present disclosure will become more readily apparent to those ordinarily skilled in the art after reviewing the following detailed description and accompanying drawings, in which:

FIG. 1A is a schematic view illustrating a track linearity effect resulted by an object with high movement rate;

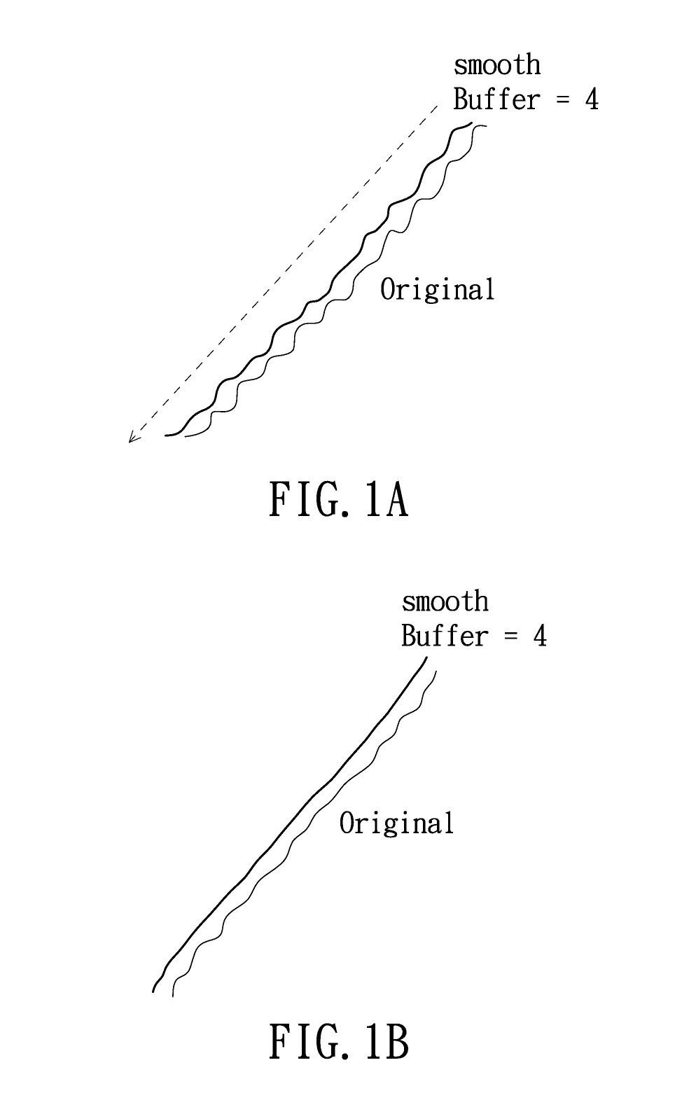

FIG. 1B is a schematic view illustrating a track linearity effect resulted by an object with low movement rate;

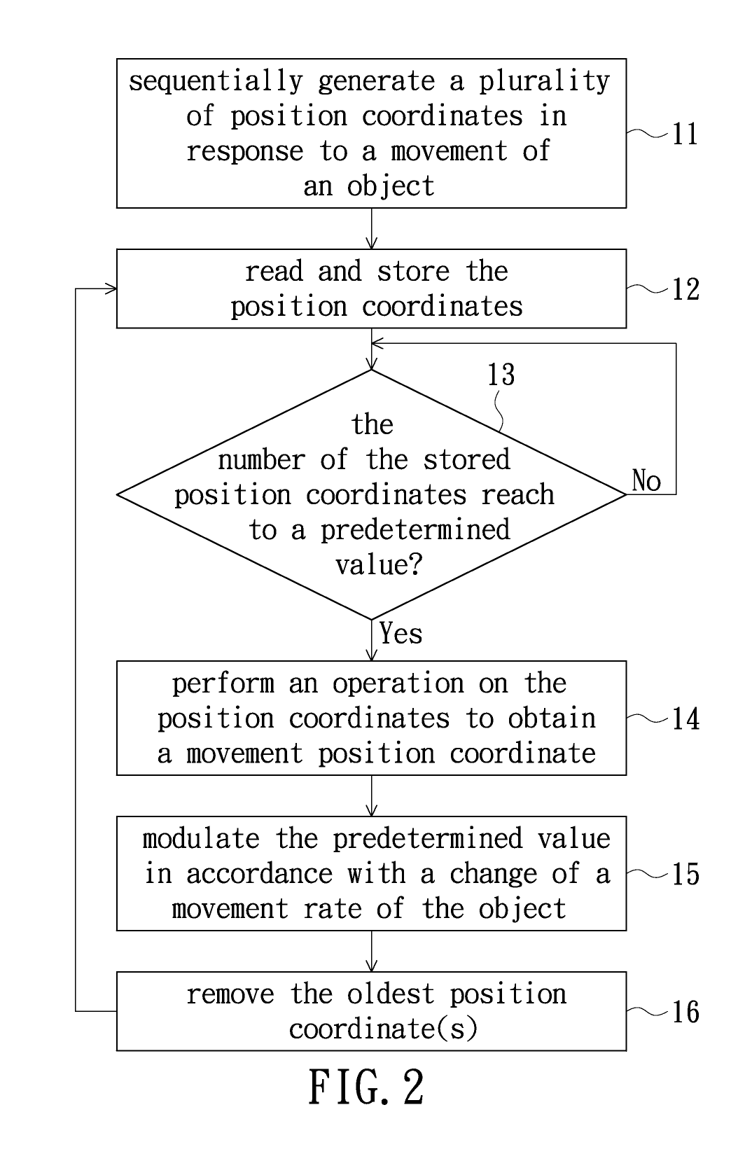

FIG. 2 is a flow chart illustrating a method for generating a movement position coordinate in accordance with an embodiment of the present disclosure;

FIG. 3 schematically illustrates a functional block view of a touch apparatus having a movement position coordinate generating device in accordance with another embodiment of the present disclosure;

FIGS. 4A, 4B schematically illustrate a modulation of the predetermined value in accordance with a change of a movement rate of the object; and

FIG. 5A, 5B schematically illustrate an improved track linearity effect when the predetermined value is modulated in response to a change of a movement rate of an object.

### DETAILED DESCRIPTION OF PREFERRED EMBODIMENTS

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

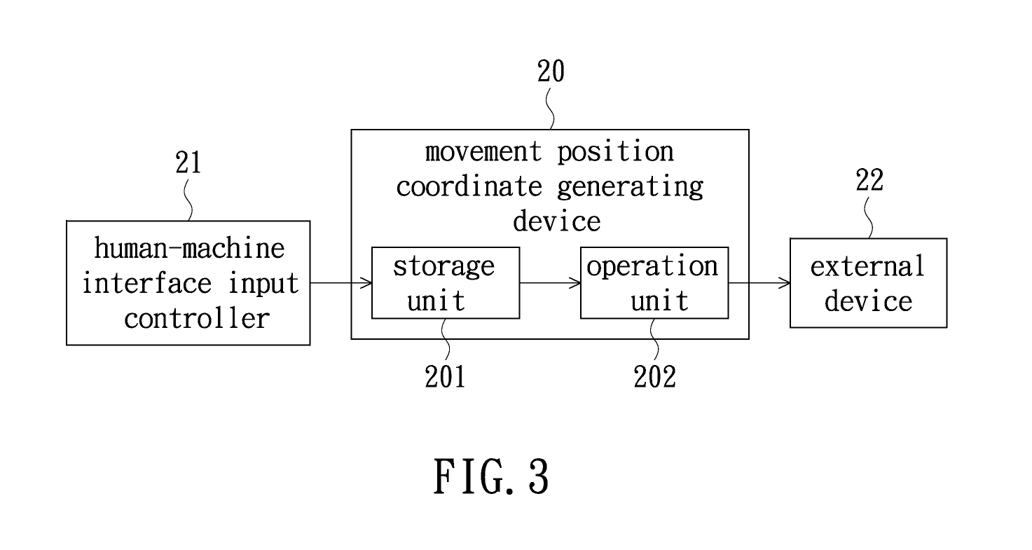

Please refer to FIG. 2, which is a flow chart illustrating a method for generating a movement position coordinate in accordance with an embodiment of the present disclosure. First, a plurality of touched-point position coordinates are sequentially generated by a human-machine interface input controller in response to touches and movements of an object (step 11). In an embodiment of the human-machine interface input controller being implemented by a touch panel controller, the human-machine interface input controller is configured to sequentially generate a plurality of touched-point position coordinates in response to touches and movements of an object (a finger or a pen of a user) on a touch panel. Basically, because the human-machine interface input controller is configured to have a constant sampling frequency, the number of the touched-point position coordinates generated in a specific time period is a constant. The generated touched-point position coordinates are read and stored (step 12); wherein the generated touched-point position coordinates may be stored in a storage unit. The touched-point position coordinates stored in the storage unit are determined whether or not having a number thereof reaching to a predetermined value (step 13). If the number reaches to the predetermined value, a specific operation is performed on the touched-point position coordinates to obtain a movement position coordinate, which indicates a movement of the touched-point position coordinates (step 14).

In an embodiment, the aforementioned operation is weighted mean operation; wherein the latest generated touched-point position coordinate(s) has a higher or a lower weight. In another embodiment, the aforementioned operation is an averaging operation, which indicates that all generated touched-point position coordinates have the same weight. In still another embodiment, the aforementioned operation is an intermediate value operation.

Furthermore, to prevent the issue of the track linearity effect being affected by the varying movement rates of the object (a finger of a user or a touch pen), the predetermined value is modulated in accordance with a change of the movement rate of the object (step 15). It is understood that a better linearity but a larger latency (a distance between the actual touched point and the track) are obtained with a larger predetermined value and a poor linearity but a smaller latency are obtained with a smaller predetermined value. It is understood that there exists the same number of the touched-point position coordinates in a specific time period under a condition of having a constant predetermined value and a constant sampling frequency. Thus, if the object has a relatively-low movement rate, a corresponding short movement distance of the object in a specific time period may generate a sufficient number of touched-point position coordinates for the calculation of the movement position coordinate; alternatively, if the object has a relatively-high movement rate, a relatively-longer movement distance of the object in a specific time period may required for generating a sufficient number of touched-point position coordinates for the calculation of the movement position coordinate. However, a relatively-short or a relatively-long movement distance may result in adverse impacts. Thus, the predetermined value is modulated in accordance with a change of the movement rate of the object (step 15); and the oldest stored touched-point position coordinate(s) is accordingly deleted if necessary (step 16). Then, the method moves back to step 12 for reading and storing the new touched-point position coordinates.

The estimation of the movement rate of the object may be realized by: calculating a plurality of coordinate differences in accordance with respective two adjacent touched-point position coordinates; and summing the coordinate differences and referring the sum of the coordinate differences to as a movement distance of the object. It is to be noted that the movement distance may be referred to as a movement rate within a specific time period if the human-machine interface input controller is configured to have a constant sampling frequency. Accordingly, the object is indicated as having a relatively-high movement rate if there exists a relatively-long movement distance; otherwise, the object is indicated as having a relatively-low movement rate if there exists a relatively-short movement distance.

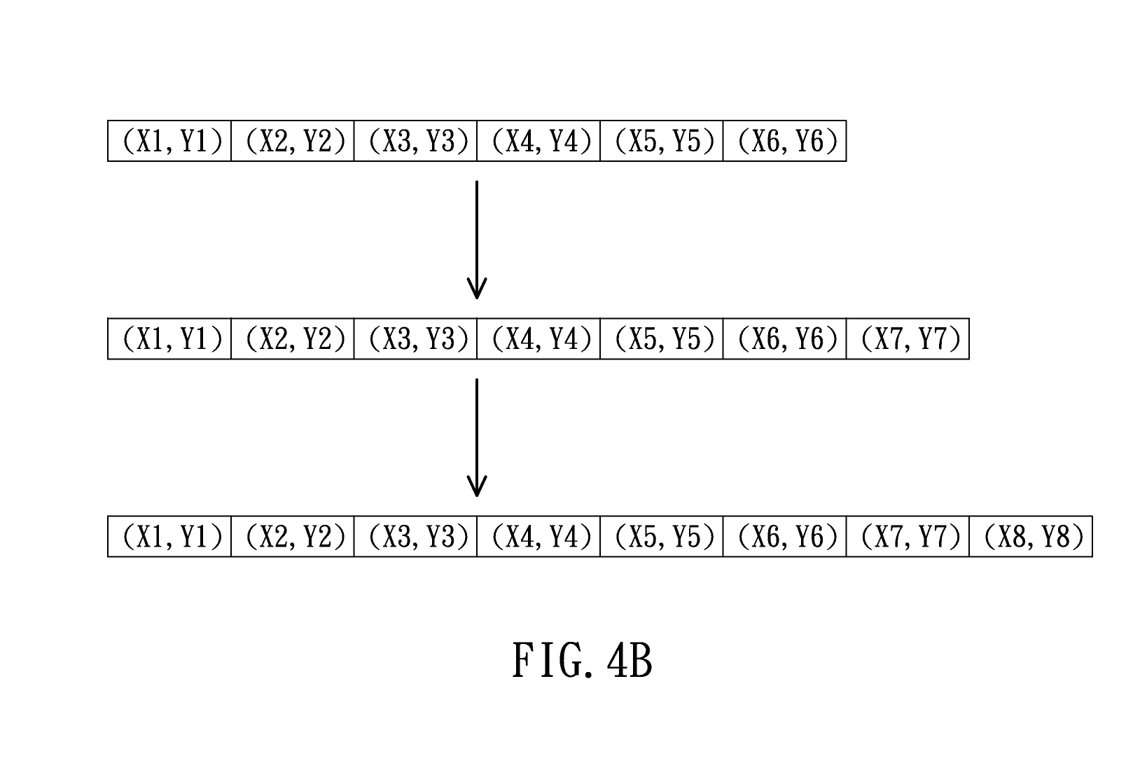

Specifically, the aforementioned step 15 may be realized by: decreasing the predetermined value in response to an increasing of the movement rate of the object; increasing the predetermined value in response to a decreasing of the movement rate of the object; or decreasing the predetermined value in response to an increasing of the movement rate of the object as well as increasing the predetermined value in response to a decreasing of the movement rate of the object. Thus, the distance required for the number of the touched-point position coordinates reaching to the predetermined value can be controlled in a reasonable range; and consequentially the adverse impacts (e.g., an uneven track linearity) resulted from the relatively-long or relatively-short movement distance are avoided. For example, as illustrated in FIG. 4A, the predetermined value, a plurality of speed ranges corresponding to respective predetermined values and maximum distance thresholds are set when a related system is being initialized; wherein the predetermined value may be set manually or automatically based on different rate ranges and desired sensitivities, and the predetermined value is set to 6 initially herein. As shown, six touched-point position coordinates (X1, Y1), (X2, Y2), (X3, Y3), (X4, Y4), (X5, Y5), (X6, Y6) are sequentially generated by the respective samplings. The six touched-point position coordinates (X1, Y1), (X2, Y2), (X3, Y3), (X4, Y4), (X5, Y5), (X6, Y6) are then stored and performed by a specific operation to obtain a movement position coordinate, which is referred to as the movement of the six touched-point position coordinates (X1, Y1), (X2, Y2), (X3, Y3), (X4, Y4), (X5, Y5), (X6, Y6). The object is indicated as having a relatively-high movement rate if the summed distance of the six touched-point position coordinates (X1, Y1), (X2, Y2), (X3, Y3), (X4, Y4), (X5, Y5), (X6, Y6) is greater than the predetermined maximum distance threshold corresponding to predetermined value 6. And accordingly, the predetermined value is modulated to 5 in the next detection so as to avoid the calculating error resulted from the relatively-long movement distance. As shown, the predetermined value is modulated to 5 in the next detection and accordingly five touched-point position coordinates (X1, Y1), (X2, Y2), (X3, Y3), (X4, Y4), (X5, Y5) are sequentially generated by the respective samplings. The follow-up operations have been described above, and no redundant detail is to be given herein. Based on the same manner, the object is indicated as having a relatively-high movement rate if the summed distance of the five touched-point position coordinates (X1, Y1), (X2, Y2), (X3, Y3), (X4, Y4), (X5, Y5) is greater than the predetermined maximum distance threshold corresponding to predetermined value 5. And accordingly, the predetermined value is further modulated to four in the next next detection. As shown, the predetermined value is modulated to four in the next next detection and accordingly four touched-point position coordinates (X1, Y1), (X2, Y2), (X3, Y3), (X4, Y4) are sequentially generated by the respective samplings. The follow-up operations have been described above, and no redundant detail is to be given herein.

In another example as illustrated in FIG. 4B, the predetermined value, a plurality of speed ranges corresponding to respective predetermined values and minimum distance thresholds are set when a related system is being initialized; wherein the predetermined value is set to six initially herein. As shown, six touched-point position coordinates (X1, Y1), (X2, Y2), (X3, Y3), (X4, Y4), (X5, Y5), (X6, Y6) are sequentially generated by the respective samplings. The six touched-point position coordinates (X1, Y1), (X2, Y2), (X3, Y3), (X4, Y4), (X5, Y5), (X6, Y6) are then stored and performed by a specific operation to obtain a movement position coordinate, which is referred to as the movement of the six touched-point position coordinates (X1, Y1), (X2, Y2), (X3, Y3), (X4, Y4), (X5, Y5), (X6, Y6). The object is indicated as having a relatively-high movement rate if the summed distance of the six touched-point position coordinates (X1, Y1), (X2, Y2), (X3, Y3), (X4, Y4), (X5, Y5), (X6, Y6) is smaller than the predetermined minimum distance threshold corresponding to predetermined value 6. And accordingly, the predetermined value is modulated to seven in the next detection so as to generate sufficient touched-point position coordinates in a specific time. As shown, the predetermined value is modulated to seven in the next detection and accordingly seven touched-point position coordinates (X1, Y1), (X2, Y2), (X3, Y3), (X4, Y4), (X5, Y5), (X6, Y6), (X7, Y7) are sequentially generated by the respective samplings. The follow-up operations have been described above, and no redundant detail is to be given herein. Based on the same manner, the object is indicated as having a still-relatively-low movement rate if the summed distance of the seven touched-point position coordinates (X1, Y1), (X2, Y2), (X3, Y3), (X4, Y4), (X5, Y5), (X6, Y6), (X7, Y7) is smaller than the predetermined maximum distance threshold corresponding to predetermined value 7. And accordingly, the predetermined value is further modulated to eight in the next next detection. As shown, the predetermined value is modulated to 8 in the next next detection and accordingly eight touched-point position coordinates (X1, Y1), (X2, Y2), (X3, Y3), (X4, Y4), (X5, Y5), (X6, Y6), (X7, Y7), (X8, Y8) are sequentially generated by the respective samplings. The follow-up operations have been described above, and no redundant detail is to be given herein.

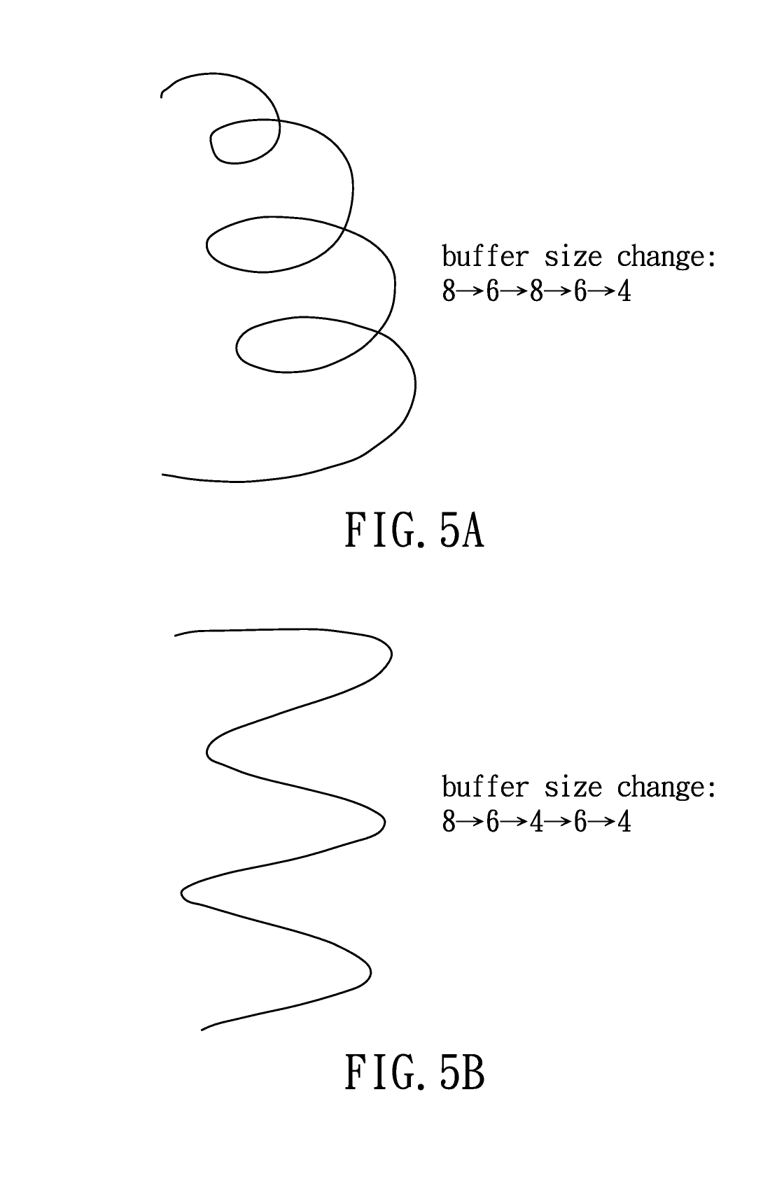

Thus, as illustrated in FIG. 5A, the method for generating a movement position coordinate in one embodiment has an improved track linearity effect when the predetermined value is sequentially modulated from 8, 6, 8, 6 to 4 in response to a change of a movement rate of the object. In another embodiment as illustrated in FIG. 5B, the method for generating a movement position coordinate in one embodiment has an improved track linearity effect when the predetermined value is sequentially modulated from 8, 6, 4, 6 to 4 in response to a change of a movement rate of the object.

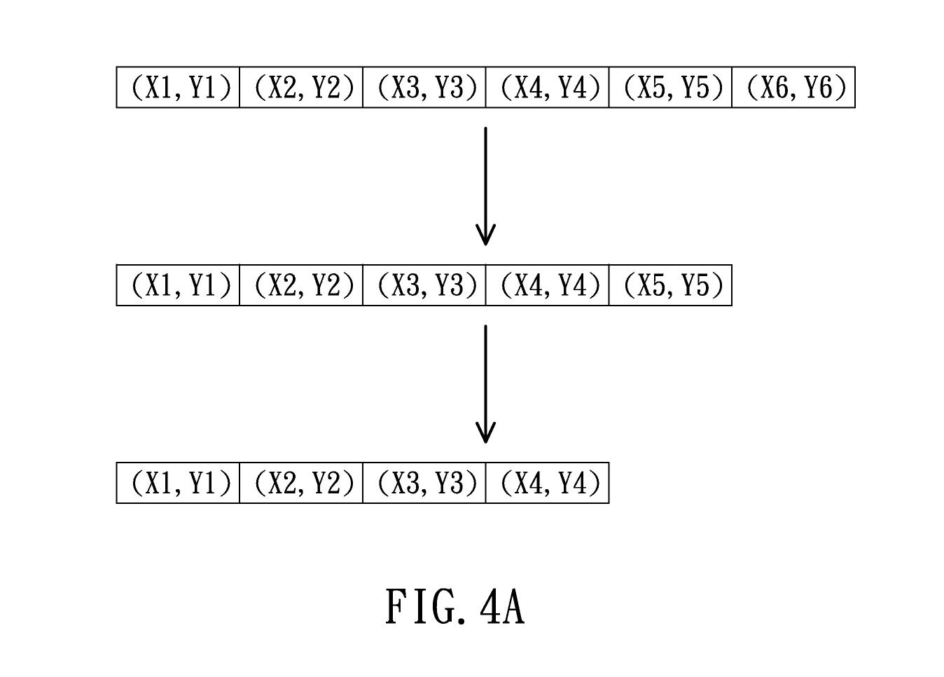

Please refer to FIG. 3, which schematically illustrates a functional block view of a touch apparatus having a movement position coordinate generating device in accordance with another embodiment of the present disclosure. The touch apparatus in this embodiment includes a movement position coordinate generating device 20, a human-machine interface input controller 21 and an external device 22; wherein the movement position coordinate generating device 20 may be disposed in the human-machine interface input controller 21. The human-machine interface input controller 21 is configured to sequentially generate a plurality of touched-point position coordinates in response to a movement of an object (not shown). The movement position coordinate generating device 20 includes a storage unit 201 and an operation unit 202. The storage unit 201 is configured to store the touched-point position coordinates generated by the movement position coordinate generating device 20. The operation unit 202 is in communication with the storage unit 201 and configured to, if the number of the touched-point position coordinates stored in the storage unit 201 reaches to a predetermined value, perform an operation on the touched-point position coordinates to obtain a movement position coordinate, estimate a movement rate of the object according to a change of the touched-point position coordinates, and modulate the predetermined value according to a change of the movement rate of the object. The movement position coordinate is then transmitted to the external device 22 (for example, an information system apparatus such as a touch panel, a touch display apparatus, a mobile display apparatus or an interactive display apparatus) and used to control an indicator object (e.g., a cursor or a brush) of the external device 22.

For example, the human-machine interface input controller 21, if being implemented by a touch panel controller, is configured to sequentially generate a plurality of touched-point position coordinates in response to a movement of an object (e.g., a finger of a user or a touch pen) on a touch panel. Because there may exist a constant number of generated touched-point position coordinates within a specific period due to the sampling frequency of the human-machine interface input controller 21 is a constant, the operation unit 202 may be configured to, if the number of the touched-point position coordinates stored in the storage unit 201 reaches to a predetermined value, perform an operation on the touched-point position coordinates to obtain a movement position coordinate; wherein the movement position coordinate herein indicates the movement of the object on the touch panel.

The actions performed by the operation unit 202, such as the determination of the number of the touched-point position coordinates stored in the storage unit 201 whether or not reaching to a predetermined value, the execution of the follow-up operations on the touched-point position coordinates to obtain a movement position coordinate and the modulation of the predetermined value according to the change of the movement rate of the object, are described in the related descriptions in steps 13, 14, and 15 shown in FIG. 2, and no redundant detail is to be given herein. In addition, the action, performed by the operation unit 202, of estimating the movement rate of the object according to the change of the touched-point position coordinates may be realized by: calculating a plurality of coordinate differences in accordance with respective two adjacent touched-point position coordinates; and summing the coordinate differences and referring the sum of the coordinate differences to as a movement distance of the object. It is to be noted that the movement distance may be referred to as a movement rate within a specific time period if the human-machine interface input controller 21 has a constant sampling frequency.

In addition, it is understood that the software methods and hardware devices related in the present disclosure may be implemented through firmware. For example, the storage unit 201 may be implemented by a queue buffer having an adjustable length. Thus, the modulation of the predetermined value can be realized by adjusting the length of the queue buffer; and the operation on the stored touched-point position coordinates is activated if the queue buffer is occupied.

In summary, the technical mean of the present disclosure may be widely used in all kinds of man-machine interface input device, such as touchpad, touch display, trackball, mouse or any device capable of tracking or recording object's moving trajectory.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for generating a movement position coordinate adapted to be used in a human-machine interface input controller, the method comprising steps of:
sequentially generating a plurality of position coordinates by detecting a movement of an object;
reading and storing the position coordinates;
performing, when the number of the stored position coordinates reaches to a predetermined value, an operation on the position coordinates to obtain a movement position coordinate; and
modulating the predetermined value in accordance with a change of a movement rate of the object.

2. The method according to claim 1, wherein the operation is an averaging operation.

3. The method according to claim 1, wherein the operation is a weighted mean operation.

4. The method according to claim 1, wherein the operation is an intermediate value operation.

5. The method according to claim 1, wherein the step of modulating the predetermined value in accordance with a change of a movement rate of the object comprises a step of:
decreasing the predetermined value with an increasing of the movement rate of the object.

6. The method according to claim 1, wherein the step of modulating the predetermined value in accordance with a change of a movement rate of the object comprises a step of:
increasing the predetermined value with a decreasing of the movement rate of the object.

7. The method according to claim 1, wherein the step of modulating the predetermined value in accordance with a change of a movement rate of the object comprises steps of:
calculating a plurality of coordinate differences in accordance with respective two adjacent position coordinates;
summing the coordinate differences and referring the sum of the coordinate differences to as a movement distance of the object; and
decreasing the predetermined value if the movement distance of the object is greater than a maximum threshold of the predetermined value; or
increasing the predetermined value if the movement distance of the object is smaller than a minimum threshold of the predetermined value.

8. The method according to claim 1, further comprising:
removing the oldest one or more position coordinates after modulating the predetermined value.

9. A human-machine interface input system, comprising:
a storage unit configured to store a plurality of position coordinates sequentially generated by the human-machine interface input system in response to a movement of an object; and
an operation unit in communication with the storage unit and configured to perform, when the number of the stored position coordinates reaches to a predetermined value, an operation on the position coordinates to obtain a movement position coordinate and modulate the predetermined value in accordance with a change of a movement rate of the object.

10. The human-machine interface input system according to claim 9, wherein the operation performed by the operation unit, is an averaging operation, a weighted mean operation, or an intermediate value operation.

11. The human-machine interface input system according to claim 9, wherein the operation unit decreases the predetermined value with an increasing of the movement rate of the object.

12. The human-machine interface input system according to claim 9, wherein the operation unit increases the predetermined value with a decreasing of the movement rate of the object.

13. The human-machine interface input system according to claim 9, wherein the operation unit modulates the predetermined value by:
calculating a plurality of coordinate differences in accordance with respective two adjacent position coordinates;
summing the coordinate differences and referring the sum of the coordinate differences to as a movement distance of the object;
decreasing the predetermined value if the movement distance of the object is greater than a maximum threshold of the predetermined value; or
increasing the predetermined value if the movement distance of the object is smaller than a minimum threshold of the predetermined value.

14. The human-machine interface input system according to claim 9, wherein the object is a finger, a touch pen, or a medium driving the human-machine interface input system.
